(19) United States
(12) Patent Application Publication
(10) Pub. No.: US 2008/0007856 A1
(43) Pub. Date: Jan. 10, 2008

(54) Magnetic tape storage, method for writing data to magnetic tape, and medium for writing data program

(75) Inventors: Ken ichiro Tango, Kawasaki (JP); Toshihiko Fujii, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/635,540

(22) Filed: Dec. 8, 2006

(30) Foreign Application Priority Data
Jul. 5, 2006 (JP) 2006-186047

(51) Int. Cl. G11B 5/09

(52) U.S. Cl. 360/53

(57) ABSTRACT

In a magnetic tape storage including a nonvolatile buffer memory, the buffer memory memorizing sets of data sent from a host computer, a set of data including a pair of one file and one tape mark, the tape mark showing the end of the file, sets of data are continuously stored in the buffer memory until the total data amount of the sets of data comes up to a predetermined data amount, and the sets of data stored in the buffer memory are wrote to a magnetic tape (called flushing) when the total data amount of the sets of data in the buffer memory exceeds the predetermined data amount. The frequency of the flushing and tape reposition according to the flushing can be greatly decreased. The wear-out of the magnetic tape and mechanical section relating to the magnetic tape running in the storage can be reduced.

### BACKGROUND OF THE INVENTION

(1) Field of the Invention

The present invention relates to a technique applied to writing data (to a magnetic tape), magnetic tape storages, and a storage medium on which is stored a program for writing data to a magnetic tape.

(2) Description of the Related Art

Conventionally, in a magnetic tape storage, a flushing is executed when a file and a tape mark (that shows the end of the file) from a host computer are received by the magnetic tape storage to secure the writing data to a magnetic tape. The flushing is an operation to write one file that is in the buffer memory to a magnetic tape. In the flushing, one file memorized in the buffer memory and one tape mark are written to the magnetic tape. After the flushing, a tape reposition is executed. The tape reposition (hereafter “tape reposition” called simply reposition) is to locate the tape at the position of the following top of data.

In writing a lot of small files to a magnetic tape, tape marks corresponding to the number of the files are written to the magnetic tape. A number of flushings and repositions are executed as a result. For instance, one reposition might require about five seconds. It takes a great amount of time to repositions for a great number of files, and it causes great degradation of the system.

As an example of a conventional magnetic tape storage of the LTO (Linear Tape-Open) standard that adopts a cartridge type information storage medium is briefly described as follows. The LTO standard is a magnetic tape standard jointly developed by three companies (International Business Machines Corporation, Hewlett-Packard Co., and Seagate Technology Co.). As for the main features of the standard, data is written to a tape in a magnetic tape cartridge by the linear recording method (method to record data along direction where tape runs). For instance, eight tracks data are written from a BOT (Beginning Of Tape) to a EOT (End Of Tape) by a multi-channel write head. Then eight tracks data are written on the following track from the EOT to the BOT after arriving to the EOT. And these operations are repeated. In the read operation, eight tracks data are read by a multi-channel read head. And write data checking is executed by comparing the data written to the tape with the data stored in a buffer memory during writing the data to the tape.

In addition, the positioning of magnetic R/W head is controlled by the servo information in the servo track. The servo information is written to the tape beforehand. For instance, 384 data tracks are prepared for ½-inch width tape and 768 data tracks are prepared for 1-inch width tape. One data band consists of 96 tracks. The servo track is located between data bands. Read and write head (R/W head) position is adjusted with the data tracks detecting the servo information it servo track.

Usually, a magnetic tape storage reads and/or writes data when the tape runs by the constant speed. When the transfer rate of the data sent from a host computer is lower than the normal transfer rate, the tape is sent more forward than the normal tape position that the data to be written. At this time, the magnetic tape storage stops running of the tape and runs the tape in the opposite direction, and again runs the tape in the normal direction not to make a blank domain on the tape. That is, the magnetic tape storage stops the tape that runs by the high-speed, then runs the tape in the opposite direction. It's necessary the tape returns exceeding the position in which the last data was written and again runs in the normal direction. This operation is called “backhitch”. The backhitch is executed in the following cases; the data transfer rate of the data sent by the host computer is insufficient for the magnetic tape storage, the data amount forwarded from the magnetic tape storage can not be processed by the host computer, or the data transfer between the host computer and the magnetic tape storage is interrupted. The performance of the magnetic tape storage decreases remarkably when the backhitch often happens. Furthermore, by the round trip running with the magnetic tape, the R/W head and the magnetic tape feed mechanism are greatly worn out.

The backhitch wastes time and invites unnecessary wear of the R/W head and the magnetic tape feed mechanism. A magnetic tape storage having a function to control the magnetic tape feed speed according to the change of magnetic tape speed by watching the data amount in the buffer memory of the magnetic tape storage is well known. The magnetic tape storage controls the magnetic tape speed and data writing speed according to the transfer rate of the data sent from a host computer. As a result, the magnetic tape streams by the constant rate and the frequency of the backhitch is decreased that causes performance decrease of the magnetic tape storage.

The positioning of the magnetic tape against the write head is executed in the backhitch. As stated above, a magnetic tape storage has a function to control the magnetic tape feed speed according to the change of magnetic tape speed by watching the data amount in the buffer memory of the magnetic tape storage, and the frequency of the backhitch is decreased. In the case of data amount in the buffer memory increases during the data transmitting, the magnetic tape speed is increased in data backing up and is decreased in data restoring. Oppositely, in the case of data amount in the buffer memory decreases during the data transmitting, the magnetic tape speed is decreased in backing up data and is increased in restoring data.

Conventionally, flushing is well known besides the above-mentioned backhitch. That is, whenever a magnetic tape storage receives one file and one tape mark (that shows the end of the file) from a host computer, writing the file and the tape mark to a magnetic tape is executed. Once the magnetic tape storage receives one data that includes one file and one tape mark sent by a host computer, the magnetic tape storage executes a flushing.

In writing a lot of small files to a magnetic tape, tape marks corresponding to the number of the files are written to the magnetic tape. A number of flushings and repositions are executed as a result.

As a method of decreasing the frequency of the flushing, for example, the method of returning host computer “Completion” report without confirming writing to the magnetic tape is known. Usually flushing is executed when a file and a magnetic tape storage receives tape mark (or a file end signal) from the host computer. However, as a problem of this method in a magnetic tape storage having a volatile DRAM buffer memory, the data in the buffer memory will be lost in an unexpected situation (for instance, if power is lost) and the magnetic tape storage can not keep data consistency with the host computer because the host computer has already received “Completion” response from the magnetic tape storage.

As a technique to solve this problem, there is a technique described in JP2005-63444. That is, a recording system of a magnetic tape drive is operated to cause one separate set of write heads to write data discontinuously to magnetic tape as received, and to save the data, and, during the same operation, to cause another separate set of write heads to rewrite data to magnetic tape in a continuous arrangement. The writing may be in parallel and simultaneous. Thus, during the same operation, and at the same time, the separate sets of the plurality of write heads, temporarily write the received data to magnetic tape so that the sender can erase its copy, and rewrite the saved data to the magnetic tape in a permanent arrangement, without waiting to complete first writing received data, to complete subsequently rewriting the data, and repeating. The data is physically written to tape before a command complete response can be made, so that the entity sending the data is able to erase its data, knowing that a copy physically exists on magnetic tape. Command requiring the tape drive to not return “Command Complete” to a write type of command, or an indication that the command has been or will be successfully executed, until it has actually committed the data to media, specifically, the magnetic tape. As the result, if power is lost, the data can be recovered from the tape, whereas it may not be recoverable from a volatile DRAM storage of the tape drive buffer.

Although the above-mentioned technology has the advantage that the magnetic tape storage can recover the data using information recorded on the tape, even if power is lost on the way of the process, It is required a technology that provide writing method more simply and surely to the tape.

### SUMMARY OF THE INVENTION

It is an object of the present invention to provide a simple method of data writing to a magnetic tape, that is, to decrease the frequency of the flushing as much as possible to do the data writing to the magnetic tape efficiently. Moreover, it aims to provide a simple method of sure recovering data method even if power is lost on the way of the processing.

The present invention relates to a technique applied to writing data (to a magnetic) in a magnetic tape storage including a nonvolatile buffer memory, a storage means, and a writing means to a magnetic tape. A nonvolatile buffer memory is for memorizing sets of data, herein one set of data includes one file and one tape mark received from a host computer. A tape mark shows the end of the file. Each file may includes a header. A storage means is for storing sets of data continuously in the nonvolatile buffer memory until total data size of sets of data comes up to a predetermined data size. A writing means is for writing sets of data stored in the nonvolatile buffer memory to a magnetic tape when total data size of sets of data exceeds the predetermined data size.

According to the present invention, the magnetic tape storage recognizes a file and a tape mark received from the host computer as one set of data. And as the above-mentioned, even if the information to be stored in the magnetic tape storage includes a lot of numbers of small files, the tape speed of the magnetic tape storage can be maintained, and the performance will be drawn out greatly. In addition, since the frequency of the flushing operation can be greatly decreased, the frequency of reposition according to the flushing are decreased correspondingly. The wear-out of the magnetic tape and mechanical section relating to the magnetic tape running in the magnetic tape storage can be reduced.

Moreover, each set of data written to the magnetic tape is verified by the read-after-write function, if power is lost, sets of data in the nonvolatile buffer memory relating the host computer has received “Completion” response, can be surely written to the magnetic tape and verification will be done at the same time. The data recovery can be executed easily keeping the data consistency with the host computer.

### BRIEF DESCRIPTION THE DRAWINGS

FIG. 1 is a diagram showing an embodiment of the present invention; and

FIG. 2 is a flowchart showing a process of the present invention.

### DETAILED DESCRIPTION OF THE INVENTION

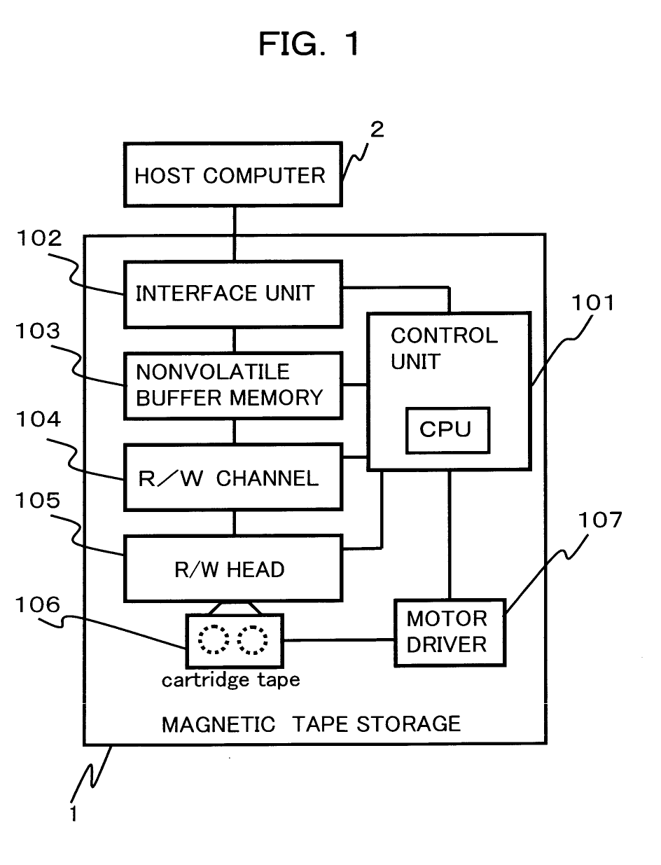

FIG. 1 shows one embodiment in accordance with the present invention. The sets of data sent from a host computer 2 via an interface unit 102 to a magnetic tape storage 1 are memorized in a nonvolatile buffer memory 103. The control unit 101 recognizes a file and a tape mark (indicating the end of the file) sent by computer 2 as a set of data. A set of data, that is a pair of one file and one tape mark in are memorized in the nonvolatile buffer memory 103. Here, buffer memory 103 is assumed to be a nonvolatile memory whose memory capacity is 128 MB. The memory amount stored in the nonvolatile buffer memory 103 is used to checked by the control unit 101. When the first set of data of 500 KB is memorized in the buffer memory 103 for instance, The control unit 101 recognizes that the data of 500 KB is kept in the buffer memory 103.

If the flushing is set to execute when the data amount stored in the nonvolatile buffer memory 103 exceeds 70 MB beforehand, the control unit 101 sets the immediate bit to “1” during the amount of sets of data does not exceeds 70 MB. That is, the control unit 101 keeps response to the host computer that the writing “Completion” to the magnetic tape and no flushing should be executed. Sets of data, Nth set of data from the first set of data, are accumulated in nonvolatile buffer memory 103. If the data amount memorized in nonvolatile buffer memory 103 exceeds 70 MB when the nonvolatile buffer memory 103 continuously receives the (N+1)th data, The control unit 101 executes flushing of (N+1) sets of data accumulated in the nonvolatile buffer memory 103. Sets of data that has been accumulated in nonvolatile buffer memory 103 are written to the magnetic tape in a magnetic cartridge tape 106 by the write head of R/W head 105 through a write channel of R/W channel 104.

As for a magnetic cartridge tape 106, the magnetic tape movement of a magnetic cartridge tape 106 is controlled by a motor not shown in the figure, and the motor is being controlled by motor driver 107. When the nonvolatile buffer memory 103 receives the (N+1)th set of data, the control unit 101 responds to the host computer 2 writing “Completion” to the magnetic tape. And a flushing is executed. Even if power is lost soon after the flushing, as the host computer 2 has already sent the (N+1) sets of data to the magnetic tape storage 1, the control unit 101 can easily recovers the (N+1) sets of data using the (N+1) sets of data memorized in the nonvolatile buffer memory 103 after restoring the power supply. And the sets of data not has been written to the magnetic tape will be written to the magnetic tape, and the written data to the tape will be examined concurrently by the read-after-write function of the magnetic tape storage 1. In the process sets of data are accumulated in the nonvolatile buffer memory 103, for instance, an identification number or a serial number that specify the tape mark of each set of data can be written in each data. Even if the power supply is lost, the control unit 101 can easily specify tape mark included in each set of data when the power supply is restored. Thus, when sets of data memorized sequentially in the nonvolatile buffer memory 103 or the order of sets of data is changed for some reasons, magnetic tape storage 1 can easily recover the sets of data keeping consistency with the host computer 2.

Plural nonvolatile buffer memories may be provided with a magnetic tape storage 1 in FIG. 1.

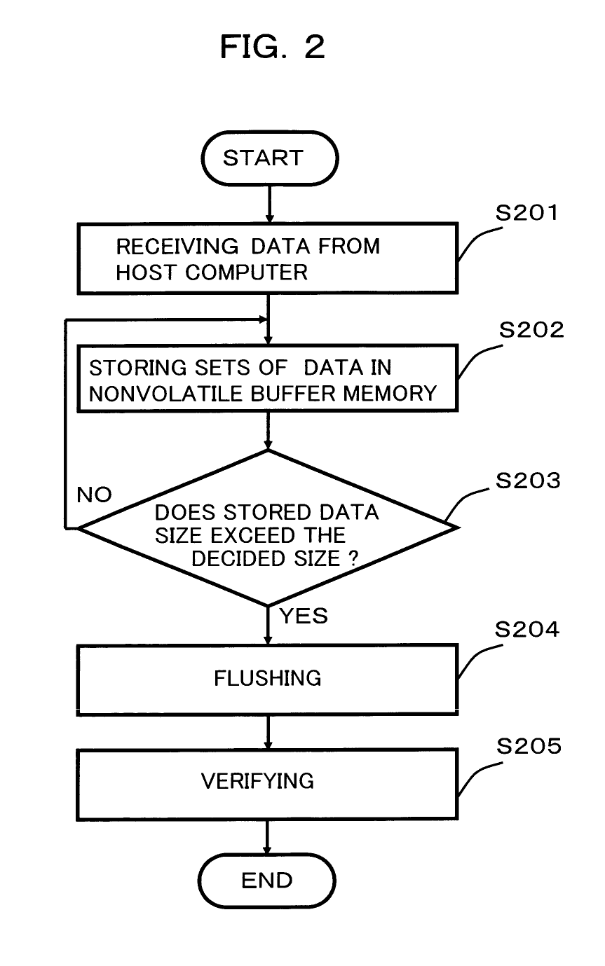

FIG. 2 is a flowchart showing a process of the present invention. When a magnetic tape storage 1 receives a data including a file and a tape mark from a host computer 2 (S201), a control unit 101 of the magnetic tape storage 1 recognizes the data as a set of data. That is, the control unit 101 recognizes a pair of a file and a tape mark indicating the end of the file sent by computer 2 as a set of data. Sets of data sent from the host computer 2 via an interface unit 102 to the magnetic tape storage 1 are stored in a nonvolatile buffer memory 103. Both the file and the tape mark in the set of data are stored in the nonvolatile buffer memory 103 (S202). The control unit 101 observes the data amount memorized in nonvolatile buffer memory 103. When the total data amount of sets of data accumulated in buffer memory 103 is under the decided data amount, sets of data are memorized one after another in the nonvolatile buffer memory 103. And the control unit 101 keeps response to the host computer 2 that the writing “Completion” to the magnetic tape and no flushing will be executed. When the total amount of sets of data accumulated in buffer memory 103 exceeds the prescribed capacity (S203), control unit 101 executes a flushing to write a set of data or sets of data memorized in buffer memory 103 to the magnetic tape (S204). When flushing is executed under the control of the control unit 101, the sets of data written to the magnetic tape are read out by the read head 105 in accordance with the read-after-write function. And by comparing the sets of data read from the magnetic tape with sets of data stored in the nonvolatile buffer memory 103, data verification is performed (S202).

As a example of the present invention, for instance, it is supposed that the memory capacity of the nonvolatile buffer memory is 128 MB. The stored data size in the nonvolatile buffer memory is checked by the tape drive control unit in the magnetic tape storage. If it is decided beforehand that the flushing is executed when the data amount of sets of data in the nonvolatile memory exceeds 70 MB and the sets of data are written to a magnetic tape. Therefore, the magnetic tape storage receives the first set of data from the host computer and stores the first set of data in the nonvolatile buffer memory, subsequently, the magnetic tape storage receives one set of data after another from the host computer and stores the first set of data in the nonvolatile buffer memory until the data amount exceeds 70 MB. When the magnetic tape storage receives the last set of data that makes the data amount in the nonvolatile buffer memory exceeds 70 MB, the magnetic tape storage executes a flushing. The sets of data stored in the nonvolatile buffer memory are written to the magnetic tape.

Conventionally, whenever a magnetic tape storage receives one file and one tape mark (that shows the end of one file) from the host computer, the magnetic tape storage stores the file in a volatile buffer memory, subsequently, the magnetic tape storage executes a flushing. And the file and a tape mark are written to a magnetic tape. In this process, only the file is stored in the volatile buffer memory excluding the tape mark. A flushing is executed for each file even if the file size of one file is a small. One tape reposition is executed after the flushing to locate the write head in the first position where the following file to be written. Moreover, when the file is written to the magnetic tape, the file placed between tape marks is considers as the object of data verification.

In the present invention, a magnetic tape storage recognizes one file and one tape mark as one set of data. And a set of data written to a magnetic tape is considers as the object of data verification. In the present invention, the control unit of a magnetic tape storage recognizes as one set of data when magnetic tape storage receives a file and tape mark from the host computer, and a file and tape mark are memorized in a nonvolatile buffer memory. Since the memorized data amount in the nonvolatile buffer memory is checked by the control unit, The control unit recognizes the data amount of 500 KB is kept in the nonvolatile buffer memory when the first set of data of 500 KB is memorized in the nonvolatile buffer memory. Herein, it is supposed that the memory capacity of the nonvolatile buffer memory is 128 MB. If it is decided beforehand that a flushing is executed when the data amount in the nonvolatile buffer memory exceeds 70 MB, the control unit keeps immediate bit to “1”, that means, the control unit keeps responses to the host computer writing “Completion” to the magnetic tape and no flushing is executed during the total data amount in the nonvolatile buffer memory is within 70 MB. N sets of data are stored in the nonvolatile buffer memory, and if the data amount in the nonvolatile buffer memory exceeds 70 MB at the time of receiving the (N+1)th set of data, a flushing is executed and (N+1) sets of data in the nonvolatile buffer memory are written to a magnetic tape.

Thus, when the nonvolatile buffer memory receives the (N+1) th set of data, the control unit executes a flushing. The host computer has sent (N+1) sets of data to the magnetic tape storage at this time. Even if the magnetic tape storage enters power-lost-state immediately after this, the magnetic tape storage keeps data consistency with the host computer since these sets of data can be recovered by the (N+1) sets of data memorized in the nonvolatile buffer memory.

According to the present invention, the accumulated plural sets of data in the buffer memory are written to a magnetic tape efficiently and reduced the frequency of the flushing and the tape reposition. Moreover, the magnetic tape storage can restore data by keeping consistency with the host computer by the data memorized in the nonvolatile buffer memory without disappearing any data sent from the host computer even if power of the magnetic tape storage is lost.

In this invention, a pair of one file and one tape mark is recognized a set of data. For instance, by adding an identification number to each data, if power is lost, the control unit of the magnetic tape storage can recover all sets of data stored in a nonvolatile buffer memory quickly.

Moreover, magnetic tape library is also a kind of magnetic tape storage in the present invention.

Furthermore, plural nonvolatile buffer memories may be provided in the magnetic tape storage.

A magnetic tape storage writes plural sets of data stored in a nonvolatile buffer memory to a magnetic tape with a write head, the sets of data written to the magnetic tape are read from the magnetic tape with a read head, and sets of data are verified by the means to verify the sets of data written in the magnetic tape.

In a magnetic tape storage by the present invention a pair of one file and one tape mark received from a host computer is handled as a set of data. Conventionally, in a magnetic tape storage, each file placed between tape marks is the object of data verification. In the present invention, a pair of a file and a tape mark is recognized as a set of data. In addition, an identification number may be added to one data. A set of data is an object of data verification. So, for instance, the magnetic tape storage will be able to use the plural sets of data saved in the nonvolatile buffer memory to keep consistency with the host computer, if power is lost. An identification number may be written in header of a file.

For instance, plural set of data are written on the magnetic tape by the multiplexer channel head of 16 tracks and those sets of data written on the magnetic tape are read soon after the writing by the multiplexer channel read head of 16 tracks by the read-after-write function means. Write data check examines if the data written on the magnetic tape and data in the buffer memory are the same or not. In the case of an error is detected, the control unit takes out the set of data corresponding to the set of data that the error occurs from the nonvolatile buffer memory, the set of data is written again after just behind the set of data being written now or after some sets of data. In this case, the information that the order of sets of data is discontinuous should be involved in the relating sets of data, or the control unit may control the order of sets of data based on the identification number written in another nonvolatile buffer memory.

In the present invention, as above-mentioned, a pair of one file and one tape mark is recognized as one set of data. The recovery of data is not expected by using a conventional volatile buffer memory in the case of power-lost. But by the present invention, data recovery is executed easily and surely.

Moreover, according to the present invention, if power is lost when the sets of data received from the host computer are memorized in the nonvolatile buffer memory or while the sets of data are written to the magnetic tape, the magnetic tape storage will be initialized itself after the power supply is restored. The magnetic tape storage by the present invention has the means to make the magnetic tape storage ready state without losing data according to the sets of data kept to a nonvolatile buffer memory.

Even if the power supply of magnetic tape storage is lost while the sets of data are written to the magnetic tape, sets of data stored in a nonvolatile buffer memory never disappears. Neither the files nor tape marks of sets of data will be lost. The sets of data can be utilized for recovering data.

Further, the method of writing data to a tape by the present invention, one file and one tape mark received from the host computer are recognized as one set of data and plural sets of data are memorized in a nonvolatile buffer memory of the magnetic tape storage. In the case of the data amount of plural sets of data memorized in the nonvolatile buffer memory doesn't come up the memory capacity that is decided beforehand in the nonvolatile buffer memory, another set of data is continuously memorized in the nonvolatile buffer memory. When the data amount of plural sets of data memorized in the nonvolatile buffer memory comes up the memory capacity that is decided beforehand in a nonvolatile buffer memory, plural sets of data memorized in the nonvolatile buffer memory is written to the magnetic tape.

A storage medium on which is stored a program for writing data to a magnetic tape in a magnetic tape storage. The magnetic tape storage memorizes sets of data in a nonvolatile buffer memory, a set of data including one file and one tape mark (showing the end of the file) received from a host computer. The magnetic tape storage stores sets of data continuously in the nonvolatile buffer memory until total data size of sets of data comes up to a predetermined data amount. The magnetic tape storage writes sets of data stored in the nonvolatile buffer memory to a magnetic tape when total data amount of sets of data exceeds said predetermined data amount.

What is claimed is:

1. A magnetic tape storage comprising:
a nonvolatile buffer memory for memorizing sets of data sent from a host computer, said data including a pair of one file and one tape mark, said tape mark showing the end of said file;
a storage means storing said sets of data continuously in said nonvolatile buffer memory until the total data amount of said sets of data comes up to a predetermined data amount; and
a writing means to write said sets of data stored in said nonvolatile buffer memory to a magnetic tape when total data amount of said sets of data exceeds said predetermined data amount.

2. The magnetic tape storage of claim 1, wherein the magnetic tape storage further includes:
a verification means of said sets of data written to the magnetic tape,
wherein said verification means reads said sets of data from said magnetic tape by a read head of magnetic tape storage and compares said sets of data with sets of data stored in said nonvolatile buffer memory.

3. The magnetic tape storage of claim 1, wherein the magnetic tape storage further includes:
a recovery means for making said magnetic tape storage ready state without losing data received from the host computer in the case that the power of the magnetic tape storage is lost during data processing;
wherein making said magnetic tape storage ready state is executed during an initializing stage of said magnetic tape storage after the power of the magnetic tape storage is recovered;
wherein said data processing includes data storing in said nonvolatile buffer memory and/or data writing to a magnetic tape; and
said recovery means further includes a data recovery means to read out each set of data received from the host computer and stored in said nonvolatile buffer memory keeping data consistency with said host computer.

4. A method of writing data to a magnetic tape storage, said method comprising the steps of:
memorizing sets of data in a nonvolatile buffer memory, said data including at least a file received from a host computer and a tape mark showing the end of said file;
storing said sets of data continuously in said nonvolatile buffer memory until total data amount of said sets of data comes up to a predetermined data amount; and
writing said sets of data stored in said nonvolatile buffer memory to a magnetic tape when total data amount of said sets of data exceeds said predetermined data amount.

5. A storage medium on which is stored a program for writing data to a magnetic tape in a magnetic tape storage, the program comprising codes for:
a step in which said magnetic tape storage memorizes sets of data sent from a host computer in a nonvolatile buffer memory, said data including a pair of a file and a tape mark showing the end of said file;
a step in which said magnetic tape storage stores said sets of data continuously in said nonvolatile buffer memory until total data amount of said sets of data comes up to a predetermined data amount; and
a step in which said magnetic tape storage writes said sets of data stored in said nonvolatile buffer memory to a magnetic tape when data amount of said sets of data stored in the nonvolatile buffer memory exceeds said predetermined data amount.
